(19) United States
(12) Patent Application Publication
(10) Pub. No.: US 2020/0388252 A1
(43) Pub. Date: Dec. 10, 2020

(54) PRECISION LIGHTWEIGHT ENVIRONMENTALLY STABLE DRUM PERCUSSION SYSTEM

(71) Applicant: SHAPE INDUSTRIES LLC, Centennial, CO (US)

(72) Inventors: Ben Pilpel, Centennial, CO (US); Ed Pilpel, Avon, CT (US)

(21) Appl. No.: 16/642,784

(22) PCT Filed: Sep. 18, 2019
(86) PCT No.: PCT/US2019/051750

§ 371 Date: Feb. 27, 2020

Related U.S. Application Data
(60) Provisional application No. 62/818,534, filed on Mar. 14, 2019.
(60) Provisional application No. 62/733,387, filed on Sep. 19, 2018.

(51) Int. Cl. G10D 13/02; G10D 13/16; G10D 13/22; G10D 13/24

(52) U.S. Cl. CPC G10D 13/02; G10D 13/16; G10D 13/20; G10D 13/24; G10D 13/22

(57) ABSTRACT

A percussion instrument comprising a polymeric material. Specifically, a polymeric shell body and a polymeric tensioning ring may be used to construct the percussion instrument. The polymeric tensioning ring may be configured to promote stiffness of the tensioning ring and reduce unwanted deflection when tensioning a drumhead using the tensioning ring. In an example, a composite polymeric material, including reinforcing fibers may be employed. The resulting percussion instrument may be lighter and provide increased dimensional stability, which may be particularly suited for percussion instruments to be used in harsh environmental conditions such as marching bands or the like.

### CROSS-REFERENCE TO RELATED APPLICATIONS

The present application is a U.S. National Stage Application under U.S.C. 371 of PCT Application Number PCT/US2019/051750 filed on Sep. 18, 2019, which claims benefit of priority to U.S. Provisional Patent Application No. 62/733,387 entitled “PRECISION LIGHT WEIGHT ENVIRONMENTALLY STABLE DRUM PERCUSSION SYSTEM” filed on Sep. 19, 2018 and U.S. Provisional Patent Application No. 62/818,534 entitled “PRECISION LIGHT WEIGHT ENVIRONMENTALLY STABLE DRUM PERCUSSION SYSTEM” filed on Mar. 14, 2019, each of which is expressly incorporated by reference herein for all that it discloses or teaches.

### BACKGROUND

Percussion instruments such as drums and membranophones are possibly the oldest form of an instrument used by mankind dating back to 6000 BC. The basic concept comprises a sheet material (e.g., animal skins in the earliest iterations) tensioned over the top, and sometimes also the bottom, of a cylinder that is struck with the hand, stick, or mallet. The materials for the construction of drums have consisted primarily of wood. More recently, metal has been introduced (e.g., in the last 100 to 150 years) as a material for construction of the hardware components of drums (e.g., clamping rim, tensioning lugs, etc.), and occasionally as a material for the drum shell.

### SUMMARY

The present disclosure generally relates to percussion instruments constructed from a polymeric material such as a composite fiber material comprising fiber reinforcement of a polymeric matrix. The instrument includes a shell body comprising a cylindrical member having a circumferential edge portion and a first thickness. The cylindrical member extends about a central axis. The shell body is made of a first polymeric material. A rim portion is positioned at the circumferential edge portion and includes a second thickness greater than the first thickness. The rim defines an outer diameter and is made from the first polymeric material. A tensioning ring having an inner diameter greater than the outer diameter may provide a slip fit interface between the rim portion and the tensioning ring. The tensioning ring includes one or more reinforced portions of increased ring height in a dimension parallel to the central axis. The tensioning ring is made from a second polymeric material.

This Summary is provided to introduce a selection of concepts in a simplified form, the concepts being further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example of a polymeric percussion instrument according to the present disclosure.

FIG. 2 illustrates an example of a cylindrical polymeric shell body.

FIG. 3 illustrates an example of a polymeric tensioning ring.

FIG. 4 illustrates an example of a drumhead having a bead extending about the circumferential perimeter of the drumhead.

FIG. 5 illustrates an exploded view of an example of a percussion instrument according to the present disclosure in which the shell body is shown in partial cut-away to illustrate various layers thereof.

FIG. 6 illustrates a cross-sectional view taken along a plane intersecting a central axis of an example percussion instrument.

FIG. 7 illustrates a detailed view of a cross-section of an example tensioning ring.

FIGS. 8-10 illustrate partial cutaway views of example shell bodies.

FIG. 11 illustrates another example of a polymeric percussion instrument according to the present disclosure with tensioning lugs integrated into a shell body.

FIG. 12 illustrates a top view of a plurality of segments of a shell body in a disassembled state and an assembled state.

FIG. 13 illustrates examples of joints that may be used between respective ones of a plurality of segments of a shell body.

FIG. 14 illustrates an example of a rim portion of a shell body and an example of joining the rim portion to a segment of the shell body.

FIG. 15 illustrates an example of a mold for molding a segment of a shell body that opens in a radial direction relative to the segment.

FIG. 16 illustrates an example of a mold for molding a segment of a shell body that opens in an axial direction relative to the segment.

### DETAILED DESCRIPTIONS

The present disclosure generally relates to percussion instruments such as drums or membranophones, that comprise a shell body and tensioning ring comprising one or more polymeric materials. As described above, most drums currently available are constructed such that the shell body of the drum is made from wood. Moreover, most tensioning rings, which are used to capture and tension a drumhead relative to the shell body, are constructed from a metallic material such as steel. However, it is presently recognized that drums constructed from materials such as wood and steel have significant drawbacks.

Traditional percussion instruments constructed from wood and/or steel are significantly heavier than a percussion instrument of corresponding dimension that is constructed from a polymeric material, particularly when constructed from a fiber-reinforced polymeric matrix such as a carbon fiber reinforced polymeric matrix. The weight of the percussion instrument may be a consideration in many contexts. For example, in some contexts a percussion instrument is carried by a player while playing an instrument. Common examples of this context include marching bands in which a player must support the weight of the instrument while playing the instrument. Moreover, marching band members often must move about while supporting the weight of the drum. Accordingly, excess weight may fatigue the player or even cause long term health problems through the increased potential for injury or the like. Even in contexts other than where a player must physically support the weight of the instrument, instruments are often transported (e.g., between venues or the like). As such, lightweight drums may provide advantages in relation to such transport making it easier and cheaper to move the instrument between venues.

The contemplated percussion instruments described herein that comprise a polymeric material may also provide benefits in relation to the environmental stability of such instruments. For example, percussion instruments may be exposed to a wide variety of environmental conditions, including varying humidity levels and temperature. Traditional materials used in the construction of drums (e.g., wood and steel) may be affected by such changing environmental conditions. For example, steel may expand and contract when exposed to varying temperatures as steel generally has a much higher coefficient of thermal expansion (CTE) than a polymeric material. In addition, wood may swell or contract at varying humidity levels. In any regard, the dimensional stability of a drum may be compromised using such materials. Additionally, steel and/or wood may deteriorate in adverse conditions (e.g., steel may oxidize, and wood may swell or rot), thus reducing the lifespan of such instruments.

In contrast, a polymeric material including, for example, a composite fiber-reinforced polymeric material, may demonstrate increased dimensional stability with respect to varying humidity levels and temperature. As such, a percussion instrument constructed from a polymeric material may demonstrate improved dimensional stability in varying environmental conditions. This may allow the instrument to demonstrate more robust tuning and more repeatable tuning. Dimensional stability of a percussion instrument may be particularly relevant to a marching band drum, which is often exposed to harsh environmental conditions including extreme temperatures, significant temperature variation, and humid environments including, for example, rain or snow.

In one example of the percussion instrument described herein, one or more components of the instrument may be constructed from a composite material comprising a polymeric matrix and a reinforcing fiber. The polymeric matrix may include a polyamide (PA) material such as PA 11 or PA 12. Such polyamides may have a relatively lower specific gravity as compared to other polymeric matrixes (e.g., including specific gravity near 1.0 such as in a range from 0.9 to 1.1), thus resulting in a lighter structure allowing increased inclusion of reinforcing fibers. Such polyamides also may be particularly resistant to moisture absorption, thus improving the dimensional stability of the resulting components. The polyamide material may be reinforced with fiber reinforcement (e.g., carbon fiber, glass fiber, or other fiber) in a fiber content range of between 1% to 75% fiber by weight. The fiber length of the fiber reinforcement may be between 5 mm and 30 mm in length in some examples.

The present disclosure may also include a drumhead comprising thermoplastic polyester PET (polyethylene terephthalate). The PET drumhead may also be a composite material in which fibers are included in a PET polymeric matrix. The inclusion of such reinforcing fibers may result in increasing impact resistance (e.g., reducing denting commonly found on the drumhead surface as a result of high force impact and creep due to tension forces and fatigue resistance). A discontinuous or continuous fiber composite can be used and may increase the impact strength significantly compared to just a polymer. Further, by adding reinforcing fibers with zero or a negative coefficient of thermal expansion (CTE) the stabilization of the skin may help provide a consistent acoustic sound and tuning.

In various examples, the percussion instrument may comprise a shell body comprising a plurality of layers of polymeric material (e.g., including one or more layers of reinforcing material such as carbon fiber sheets or the like). These layers may be provided such that a reinforcing fiber contained in each respective layer may be oriented in a particular manner relative to the other layers in the composite. This may include providing layers at orthogonal orientations and/or parallel orientations and/or any variation therebetween. Moreover, the layers may include additional materials and/or structures that may further reduce the weight of the percussion instruments. Such layers may include foams, materials with cellular voids, or other filler materials disposed between layers of the composite material. Further still, such layers may include a honeycomb or other open cell structure that facilitates retention of structural integrity, while reducing the overall weight of the percussion instrument.

In one example, the percussion instrument may comprise a segmented shell body. The segmented shell body may comprise a plurality of segments (e.g., three or more) each comprising a polymer or polymeric composite material. The segments may be joined by any appropriate means including mechanical fastening, adhesives, heat welding, joinery, or any other appropriate joining technique. The segments of the segmented shell body may each be individually constructed from the composite material. This may allow the use of compression molding processes that provide advantageous structural properties to the individual segments and facilitates ease of construction, as well as improves the moldability of individual segments as compared to molding a shell in its entirety.

While in some embodiments described herein, the percussion instrument may comprise structural components made from compression-molded components, other manufacturing techniques may also be utilized without limitation. Such techniques include injection molding techniques, additive manufacturing techniques (e.g., three-dimensional printing), or other appropriate manufacturing techniques without limitation.

While it is contemplated that the use of polymeric material may provide advantages over traditional materials (e.g., steel and wood) as described above, it is also recognized that the structural properties of such polymeric materials may provide challenges in the context of a percussion instrument. For example, such materials may be much less stiff relative to steel. Tensioning of a drumhead may be provided externally via a tensioning ring that may apply tension to the drumhead via tensioning fasteners engaged with tensioning lugs on the shell body to apply a tensioning force to the drumhead. Examples contemplated herein may utilize a polymer material or polymer matrix composite material that has a tensile modulus of elasticity (MOE) from 300 KSI (2.06 GPa) to 10,000 KSI (69.0 GPa). These materials may also have a minimum yield compression and tensile strength of 5 KSI (34.5 MPa). Tensile and compression MOE polymer values below 300 KSI (2.06 GPa) to 200 KSI (1.40 GPa) are transitioning into semi-rigid material and ultimately to elastomers as MOE decreases, which may not be suitable for production of percussion instrument components contemplated herein.

In addition, certain properties may be selected to provide increased impact resistance by avoiding materials that are brittle or may become brittle upon impact. For example, a minimum elongation at yield strength of 5% allows for the material to conform well and to stay above a brittle behavior threshold. Brittle behavior is disadvantageous as brittleness could lead to cracking during the tensioning and torquing of the tensioning ring, in addition to increasing the likelihood of impact failure. Composites and polymer materials with high elongation of 8% and greater at break will exhibit suitable conforming properties for the application. In addition, the high strength and elongation provide for multiple strike impact resistance particularly for the rim which may be exposed to significant impacting in a single area during lifetime use as a result of “rim-shots” when the musician contacts the rim with a drum stick, mallet, or the like. Additional strength may be required for percussion instruments that are larger in diameter or require higher tensioning of the membrane for acoustic performance or desired sound.

In one embodiment, percussion instruments are contemplated as being constructed from materials at the upper range yield strength of 40 KSI (276 MPa) and a maximum MOE of 10,000 KSI (69.0 GPa). In addition, for smaller drum instruments with lug torques at or below 10 in-lbs (1.13 Nm) a stress level requirement of the material may be far less. For the embodiments tested by the present inventors have material tensile MOE of between 430 KSI (2.96 GPa) and 1,100 KSI (7.58 GPa). In addition, a long carbon fiber (e.g., a fiber length of greater than about 12 mm) in a thermoplastic or thermoset matrix with a composite elongation property at yield of at least 5% may be suitable for higher torque tensioning. It should also be noted that high creep resistance is typically a function of strength, MOE, and heat resistance is also important to the overall drum functionality. Those properties described herein should suffice for proper performance of the drum system. As used herein, long fiber length may refer to fibers generally equal to or greater than 12 mm in length, based on a majority of fibers by weight. A short fiber length may refer to fibers generally equal to or less than 1 mm in length, based on a majority of fibers by weight. A medium fiber length may refer to fibers generally between 1 mm and 12 mm in length, based on a majority of fibers by weight.

In this regard, the tensile MOE range for percussion instrument materials contemplated herein may be between 300 KSI (2.06 GPa) and 10,000 KSI (69.0 GPa), and the strength at yield is a minimum of 5 KSI (34.5 MPa) for most of the typical drum set and marching band applications. The resulting MOE to yield strength ratio range from low to high may be (assuming an upper range of yield strength of 20 KSI (138 MPa)) 60 to 150. In contrast, traditional drum rim membrane tensioning rings have been contemplated as being made with high stiffness and strength materials—most often steel. For a nominal steel product with typical MOE of 29,000 KSI (200 GPa) and a range of yield strength for hot and cold rolled steel of between 70 KSI (483 MPa) and 45 KSI (310 MPa) the ratio of MOE to yield strength ranges from 414 to 644, respectively. As can be appreciated, the contemplated ratio of 60 to 150 for the composites or polymers to be utilized herein is much below that of the ratio for traditional materials such as steel. Accordingly and as described in greater detail below, the present disclosure contemplates a tensioning ring structure for a polymeric tensioning ring that may improve the stiffness of the tensioning ring to achieve improved performance.

As an example, a typical snare drum normally would not have a greater lug torque than 50 in-lbs (5.65 Nm). For this application, a 10 KSI (69 MPa) yield strength in compression and tension should suffice to withstand the forces applied as a result of the tensioning, while maintaining enough ductility to avoid brittleness. For example, an elongation capability of the parent material of at least 5% at yield would be acceptable.

As will be described in greater detail below, the manufacturing of a composite or polymeric percussion instrument may be achieved via additive manufacturing. In one embodiment, a PA12 and short length carbon fiber (e.g., less than about 1 mm) with a MOE of 1,100 KSI (7.58 GPa) and tensile yield strength of 9 KSI (62.0 MPa) may be utilized. Another embodiment may be produced from polyethyleneimine (PEI) for the rim retaining rings, and the shell may be produced from polycarbonate. The conformable rim using the PEI may have a tensile MOE of 430 KSI (2.96 GPa) and compression MOE of 480 KSI (3.31 GPa). Elongation at yield may be 7 to 8% and at break 40%. Shear strength may also be quite high at 15 KSI (103 MPa).

The acoustic tonal performance and volume of the drum have also been found to be a function primarily of the tensile modulus of elasticity, and the intimate slip fit facilitated between drum shell, drum membrane, and tensioning ring. The primary operating range for sound adjustment of the present invention for shell and rim or hoop is a tensile MOE range of 300 KSI (2.06 GPa) to 10,000 KSI (69 GPa), When employing just polymer (e.g., in the absence of reinforcing fibers) the range should be a minimum of 300 KSI (2.06 GPa), and may have no upper limit. When fibers such as glass, carbon, carbon fiber, recycled carbon fiber graphite, Kevlar, hemp, basalt or other fibers are employed in a composite the combined tensile MOE may not exceed 10,000 KSI (69 GPa). The practical fiber by weight may range from 1% and up to 75%. Depending on polymer, the addition of fibers, in general, may decrease both the elongation at yield and ultimate break strength of the material. Greater or equal to 5% elongation at yield and 10% elongation at break will account for most applications where the impact durability of the tensioning ring is desired. For other percussion applications such as congas or kettledrums, the elongation properties are not as important as “rim shots” in which the tensioning ring and/or drum shell are contacted by the player are not typical.

Accordingly, it has been found that the material properties of the materials used to construct the percussion instruments may have a direct relation to the acoustic performance of the percussion instrument. For instance, higher modulus shell and rims may have a distinctively different sound than those with a lower modulus. Specifically, it has been found that higher modulus materials may produce a harder more rock sound, with stronger punch and increased sound level when struck in the center portion of the drumhead. In contrast, embodiments having modulus values in the lower end of the ranges described above may provide a more of a Latin, jazz and some similarities to a marching band snare acoustic performance. That is, the variations adjust key mechanical properties, primarily the tensile MOE, strength, impact, and elongation at yield and break to provide attendant acoustic performance changes. Adjustment of the fiber weight or volume may affect the tensile MOE which is the most significant contributor to changes in acoustic performance and vibrational characteristics. Density is also a key factor for acoustic performance. The polymer type and fiber types can be employed in such a way that the acoustic performance and output characteristics such as volume level, frequency output, and vibration characteristics can be varied. In this regard, a plurality of tensioning rings comprising different materials may be provided to achieve unique acoustic properties. For instance, a first tensioning ring comprising a first material may be provided to achieve a first acoustic property and a second tensioning ring comprising a second material may be provided to achieve a second acoustic property. The first and second tensioning rings may be interchangeably utilized with a shell body to achieve the desired acoustic property of a player. In this regard, a kit may include a drum shell and a plurality of different tensioning rings comprising different materials.

From a performance standpoint, the fiber content can be varied, and higher material tensile modulus can be achieved over injection molding and 3D printing. The modulus variability will relate to acoustic performance in terms of brightness and sustain—the higher the modulus, the brighter the sound based on higher resonance frequencies that can be generated. In addition, the decay rate of a given impact to the drumhead will sustain longer and the decay time and character/curvature of the decay curve will change.

While certain specific polymeric materials are contemplated in examples herein, other polymeric materials may be used. Examples of such polymeric materials or polymeric matrices can be a thermoplastic or a thermoset polymer. As described herein, a polymeric material is intended to encompass a polymeric matrix of a composite material, which may include reinforcing fibers or the like. As such, the polymeric material may include a polymeric resin applied to a fiber reinforcing material such as bulk fiber, fiber tow, fiber sheets (whether unidirectional or woven), or another fiber form without limitation. Nonlimiting examples of polymeric materials include, polypropylene, polyethylene (e.g., high density polyethylene (HDPE), low density polyethylene (LDPE), high molecular weight (HMW) polyethylene, ultrahigh molecular weight (UHMW) polyethylene), polyethylene terephthalate, polyethylene naphthalate, polyamides, acrylonitrile butadiene styrene (ABS), thermoplastic polyurethane (TPU), polyphenylene sulfide (PPS), polycarbonate, polyethyleneimine (PEI), thermoset urethane, epoxy, polyester, vinyl ester, carbon epoxy, graphite epoxy,

In this regard, the present disclosure contemplates structural configurations of one or more of the polymeric components to facilitate improved performance. For example, the percussion instrument described herein comprises a tensioning ring that comprises a composite material. The tensioning ring is particularly configured to facilitate the ability to apply uniform tension to a drumhead that is tensioned by the tensioning ring when installed relative to the shell body. Specifically, reinforcing portions may be provided between tensioning fasteners to improve stiffness of the tensioning ring to reduce deflection of the tensioning ring between tensioning fasteners. In turn, a more uniform tension may be applied to the drumhead without unwanted variations in tension between tensioning lugs. The clamping ring may be reinforced in select areas of the tensioning ring (e.g., between apertures for receiving tensioning fasteners). Thus, the reinforced portions may reduce flexing of the tensioning ring between the such that a uniform tension on the drumhead between tensioning fastener locations may be achieved. For instance, the tension of the drumhead near apertures may be higher than the tension applied to the drumhead by the tensioning ring between tuning lugs due to flexing or other deformation of the tensioning ring in response to the applied tensioning forces. In this regard, the reinforced portions of the tensioning ring may be provided to reduce such deformation, thus increasing the stiffness of the tensioning ring and allowing improved tensioning performance.

Given the approaches described herein, the percussion instrument described herein may take the form of nontraditional shapes not commonly provided in the traditional percussion instrument field. Specifically, the shape, size, and or construction of the percussion instrument may be specifically provided to facilitate given acoustical properties desired in the percussion instrument. This may include a non-cylindrical drum shell and/or a drum shell comprising apertures or other discontinuities that may facilitate advantageous sound properties. Thus, while generally cylindrical shapes are described herein, the disclosure is not limited to this configuration, and other shapes and/or configurations of percussion instruments may be realized without limitation. Moreover, any type of percussion instrument or membranophone may be realized using the disclosed technology presented herein. In turn, the present disclosure may comprise examples that include without limitation, a snare drum, a raised tom-tom drum, a floor tom-tom drum, and a bass drum, any or all of which may be constructed according to the disclosure below. Other percussion instrument types are also contemplated including, for example, timbolies, timpani, conga, Djembe, Dunum, Darabouka, Damaru, and/or Dhol.

In view of the potential dimensional stability achieved by the use of polymeric materials as described herein, it may be feasible to provide a plurality of different tunings in relation to a single drumhead of the percussion instrument described herein. Thus, while it is described herein that a uniform tension may be achieved using a tensioning ring comprising reinforced portions, intentional uneven tuning across a drumhead may be accomplished as well. That is, different areas of the drumhead may be specifically tuned for different acoustical properties. Given the dimensional stability of the tensioning ring and/or drum shell through use of a polymeric material, the uneven tension applied to the drumhead to achieve the various tunings on the given drumhead may be maintained consistently over relatively long durations (e.g. days, weeks, months, etc.) without having to tune or otherwise alter the percussion instruments. Thus, while intentional variations in tension may be achieved using a tensioning ring, unwanted tension variation due to deflection of the tensioning ring may be reduced in the tensioning ring examples described herein.

Moreover, the polymeric materials described herein may be readily recyclable such that the percussion instruments described herein may be selectively recycled either at end-of-life or, in the case of defects in the manufacturing process, components under construction may also be readily recycled reducing costs associated with waste of material in the event of manufacturing defects. Specifically, the life cycle analysis (LCA) or embodied energy/carbon footprint of a given material and product combination has become an important factor to producers and consumers alike. The present disclosure may facilitate percussion instruments that have an extended service life and the ability to be recycled and repurposed for used in other products. This can be fulfilled by shredding and recycling of the bi-product stream back into the production and/or perform the same at the end of service life of the percussion instruments or repurposed to produce other products for compression molding of the shredded material or convert to injection molding pellets, for the case of composites materials utilizing thermoplastic polymers for a matrix binder. Thermoset varieties of composites can be shredded and used as fillers or converted via controlled pyrolysis to energy and the fibers reclaimed for repurposing. Chemical wash systems can also be employed to remove epoxy and polyester matrix systems and the like typically in a thermoset prepreg state and in the cured state in some cases. Still further, the objective of the present invention is to use recycled fibers and bio-based matrix systems as primary constituents of the composites material which are now commercially available to use. Such a material is the Arkema Rilsan PA11 produced from castor oil.

Further still, the present disclosure contemplates a tuning system that may be used to tune a percussion instrument. The tuning system may rely on a computer-executed system that may include appropriate sensors and actuators to facilitate automated or partially automated tuning of a percussion instrument. As will be discussed in greater detail below, use of such a system may be particularly suited in the context of a polymeric percussion instrument due, at least in part, to the advantages in tuning provided in such an instrument.

In view of the foregoing, the present disclosure presents examples related to percussion instruments comprising a polymeric material. Such polymeric materials may be but are not required to be, reinforced composite materials such as carbon fiber reinforced polymers. Specifically, it is presently recognized that production of percussion instruments from polymeric materials according to the descriptions presented herein may provide a number of advantages over traditional percussion instruments, which are typically constructed from wood with metallic materials used for tensioning devices of the drum. As will be described herein, any of the major components of a percussion instrument may be constructed from a polymeric material as described herein. Notably, a drum shell, a drum membrane (or drumhead), a tension ring, and/or tensioning hardware of a percussion instrument may be constructed from one or more polymeric materials. For instance, all components of the percussion instrument may be constructed from a common polymeric material, or different ones of the components may be constructed from different polymeric materials (e.g., to achieve specific benefits for each respective component).

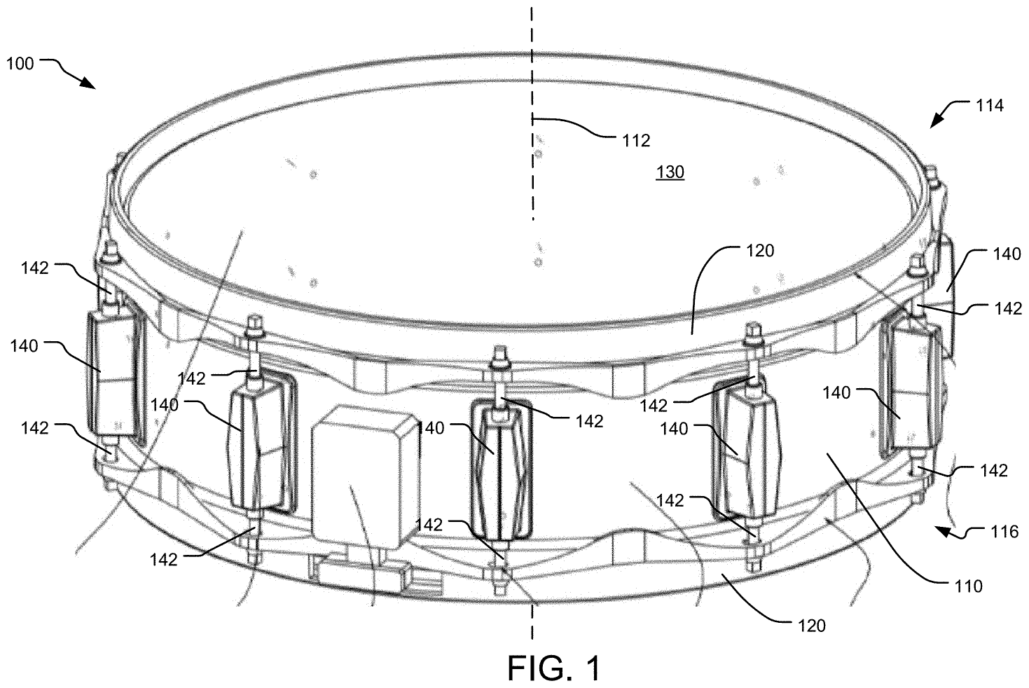

FIG. 1 illustrates an example of a percussion instrument 100. As will be described in greater detail below, one or more components of the percussion instrument 100 may comprise a polymeric material, which may be a reinforced composite polymeric material. The percussion instrument 100 includes a shell body 110. The shell body 110 may be a cylindrical member having an outer diameter. The cylindrical shell body 110 may define a central axis 112 about which the cylindrical member comprising the shell body extends. A tensioning ring 120 is provided that has an inner diameter greater than the outer diameter of the shell body 110. In turn, the tensioning ring 120 may be positioned relative to the shell body 110 to have a slip-fit engagement in which the tensioning ring 120 may be concentrically disposed about the outside of the shell body 110 when axially aligned with the shell body 110. As shown, a tensioning ring 120 may be provided on a first end 114 and a second end 116 of the shell body 110. However, in other examples, a tensioning ring 120 may be provided on only one end of the shell body 110.

As described in greater detail below, a drumhead 130 may be captured between the tensioning ring 120 and the shell body 110. In this regard, the tensioning ring 120 may be used to tension the drumhead 130 relative to the shell body 110. Specifically, a plurality of tensioning lugs 140 may be disposed about the shell body 110. Tensioning fasteners 142 may pass through the tensioning ring 120 and engage the tensioning lugs 140. For instance, the tensioning fasteners 142 may include a threaded end that engages a corresponding threaded portion of the tensioning lug 140. In turn, threaded advancement and retraction of the tensioning fasteners 142 relative to the tensioning lug 140 may move the tensioning ring 120 to control a tensioning force applied to the drumhead 130.

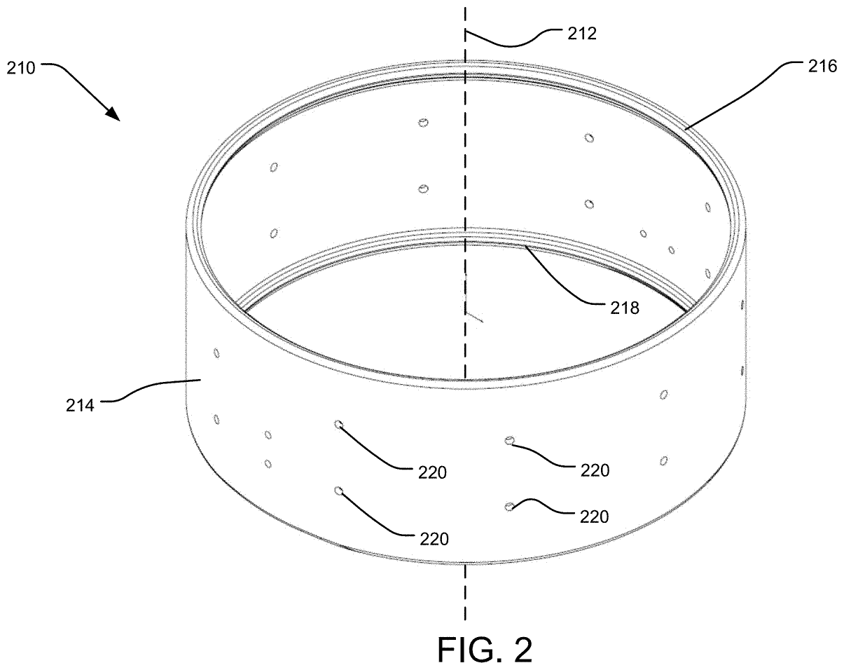

FIG. 2 illustrates an example of a shell body 210. As described above, the shell body 210 may include a cylindrical member 214 that extends about a central axis 212. A first rim portion 216 is provided at a first edge portion of the cylindrical member 214 and a second rim portion 218 is provided at a second edge portion of the cylindrical member 214. A plurality of mounting locations 220 may be provided. As an example, tensioning lugs may be affixed to the cylindrical member 214 using the mounting locations 220, which may comprise through-holes extending through the cylindrical member 214 that receive fasteners to secure a tensioning lug to an exterior of the cylindrical member 214.

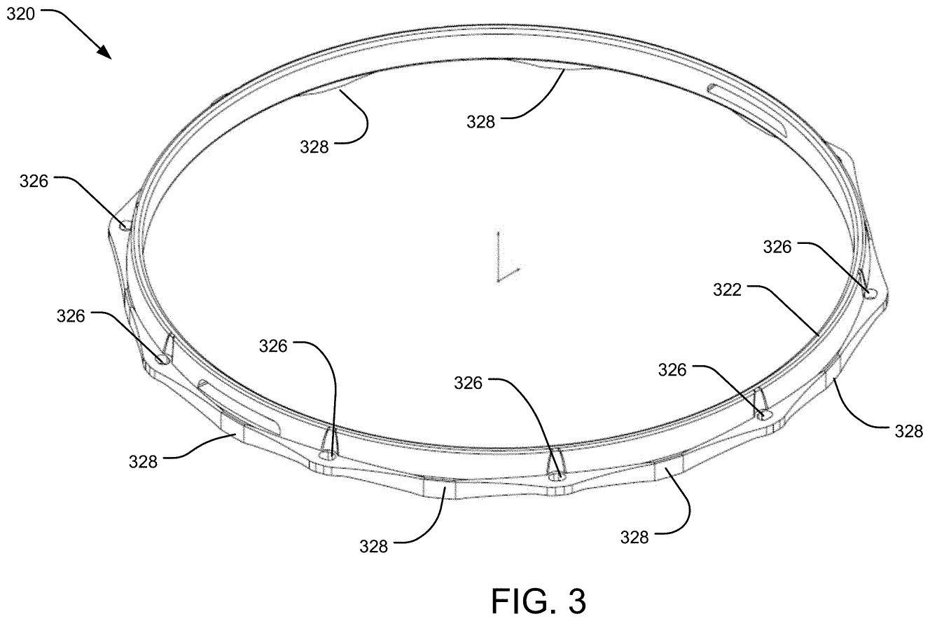

FIG. 3 illustrates an example of a tensioning ring 320. The tensioning ring 320 includes an annular wall 322. In addition, a plurality of apertures 326 are defined in the tensioning ring 320. The apertures 326 of the tensioning ring 320 may receive tensioning fasteners for use in tensioning a drumhead. In addition, the tensioning ring 320 includes a plurality of reinforced portions 328. As can be appreciated, the reinforced portions 328 may generally extend between adjacent apertures 326 of the tensioning ring 320.

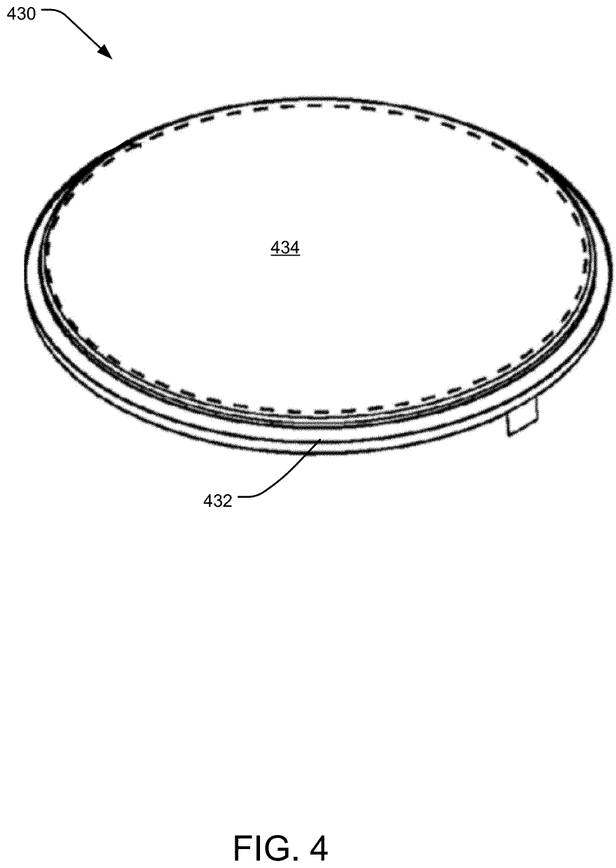

FIG. 4 illustrates an example of a drumhead 430. The drumhead 430 may include a drum skin 434 and a bead 432. The drum skin 434 may be attached to the bead 432, which may comprise a stiff annular member including, for example, a metal ring or hoop attached to the drum skin 434. As noted above, in some examples the drum skin 434 and/or bead 432 may comprise a polymeric material such as a polymeric matrix including a fiber reinforcing material.

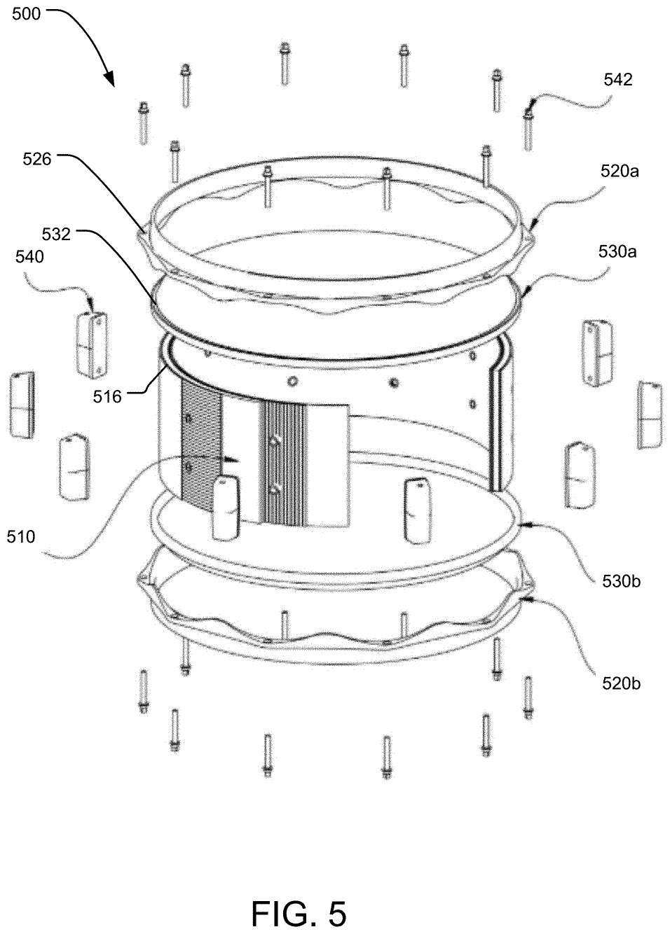

FIG. 5 illustrates an example of a percussion instrument 500 in an exploded view. The percussion instrument 500 includes a drumhead 530a disposed between a first tensioning ring 520a and a shell body 510. As can be appreciated, the drumhead 530a (e.g., a bead 532 thereof) can be contactingly engaged by the tensioning ring 520a. In turn, as the tensioning ring 520a is disposed relative to the shell body 510 for engagement in a slip-fit engagement, the bead 532 of the drumhead 530 may be contactingly engaged by the tensioning ring 520a. In turn, movement of the tensioning ring 520a in a direction toward the tensioning lugs 540 (i.e., in a direction toward a mid-line of a height of the shell body 510) may impart a tensioning force on the drumhead 530, stretching the drumhead 530 relative to a rim 516 of the shell body 510.

Tensioning fasteners 542 may be disposed through apertures 526 of the tensioning ring 520a to engage corresponding tensioning lugs 540, which may be affixed to the shell body 510. As described above, the tensioning fasteners 542 may include a threaded portion that engages corresponding threads of the tensioning lugs 540. In turn, the tensioning fasteners 542 may be used to adjust the applied tensioning force on the drumhead 530 by adjusting the position of the tensioning ring 520a when disposed about the shell body 510. As also shown in FIG. 5, a similar arrangement may be provided for a second tensioning ring 520b to similarly engage a second drumhead 530b at an edge portion of the shell body 510 opposite the rim 516. Moreover, the shell body 510 is shown in a partial cut-away fashion to illustrate a plurality of layers that may be provided in the cylindrical member of the shell body 510 as described in greater detail below.

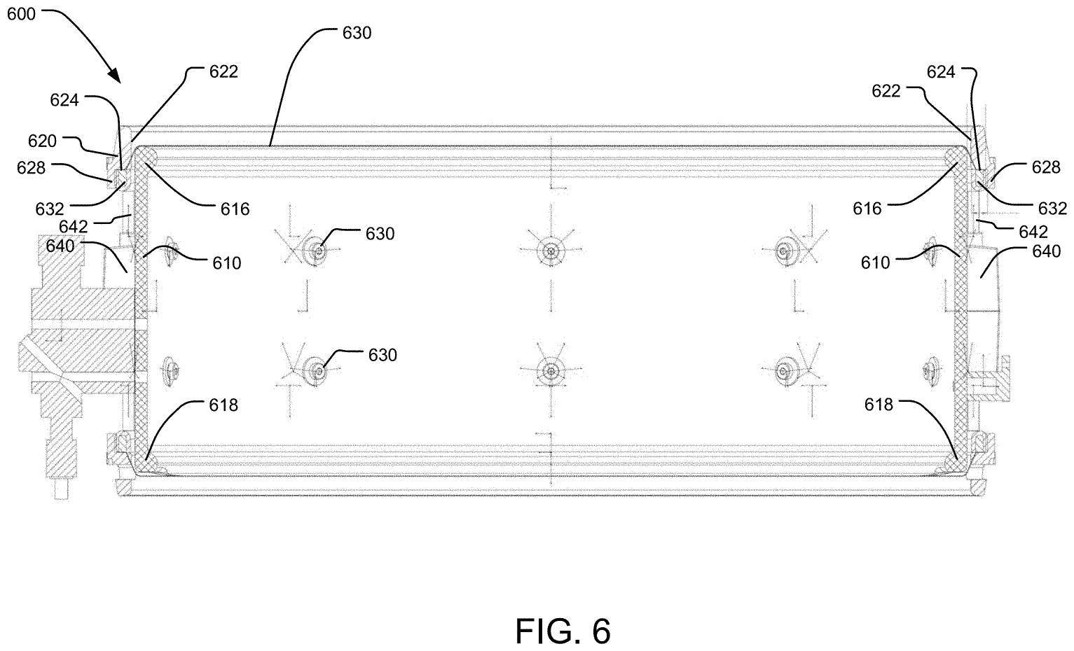

FIG. 6 illustrates a cross-sectional view taken along a plane parallel to a central axis of the percussion instrument 600. As can be appreciated in FIG. 6, a drumhead 630 is captured between a shell body 610 and a tensioning ring 620. The inner diameter of an annular wall 622 of the tensioning ring 620 is greater than an outer diameter of the shell body 610 such that the tensioning ring 620 is in slip-fit engagement with the shell body 610.

As described above, an inner diameter of the tensioning ring 620 is greater than an outer diameter of the shell body 610. In traditional drums, the tolerance of the tensioning ring relative to the shell body can be large to provide for relatively large dimensional variation in the components as described above. As the polymeric material comprising the tensioning ring 620 and the shell body 610 may have much greater dimensional stability, the tolerance between the tensioning ring 620 and the shell body 610 may be far smaller than traditional drums. For example, the inner diameter of the tensioning ring 620 may be no more than about 0.200 inches (5.8 mm) greater than the outer diameter of the shell body 610. Alternatively, the inner diameter of the tensioning ring 620 may be no more than about 0.100 inches (2.54 mm) greater than the outer diameter of the shell body 610.

In turn, a bead 632 of the drumhead 630 may be in contacting engagement with a capture surface 624 of the tensioning ring 620. In turn, as the tensioning ring 620 is moved toward the tensioning lug 640 (e.g., by advancement of the tensioning ring 620 under the influence of one or more tensioning fasteners 642), the bead 632 of the drumhead 630 may be contactingly engaged with the capture surface 624 to cause the drumhead 630 to be tensioned over the rim portion 616 of the shell body 610. The capture surface 624 may extend radially to capture the bead 632 for concurrent movement with the tensioning ring 620. As can also be seen in FIG. 6, the tensioning ring 620 comprises a plurality of reinforcement portions 628. The rim portion 616 of the shell body 610 may comprise a thickened portion relative to the remaining sidewall of the shell body 610. This may provide added strength to the rim portion 616 where the drumhead 630 may contact the shell body 610.

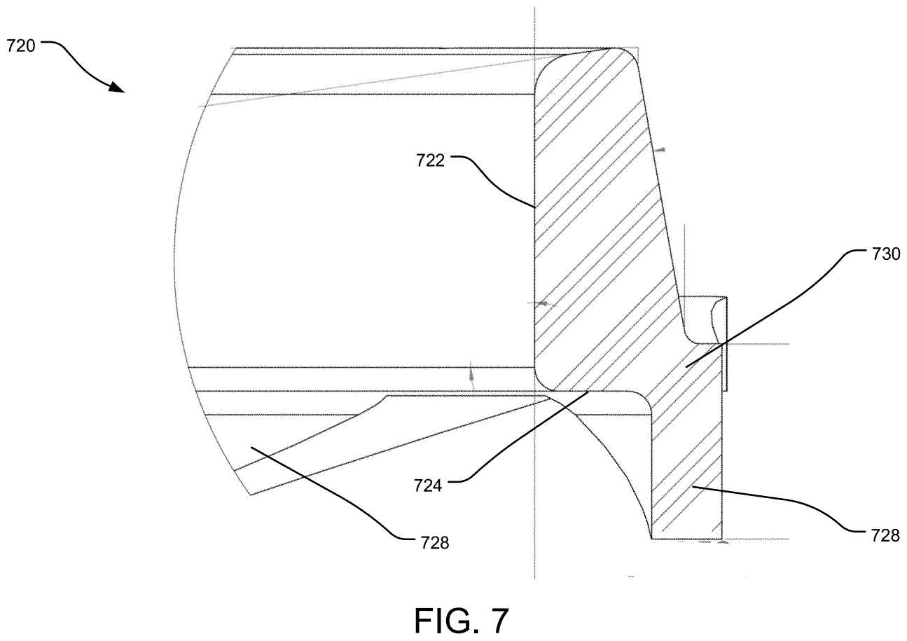

FIG. 7 illustrates a detailed cross-sectional view of a tensioning ring 720 in which a reinforcement portion 728 is shown. The tensioning ring 720 includes an annular wall 722 and a flange 730. The flange 730 may comprise a thickened portion of the tensioning ring 720. The flange 730 may include the capture surface 724. The reinforcement portion 728 comprises an increased ring height extending between adjacent ones of the plurality of tensioning apertures. The reinforcement portion 728 extends from the flange 730 at a location external to the capture surface 724 of the flange 730.

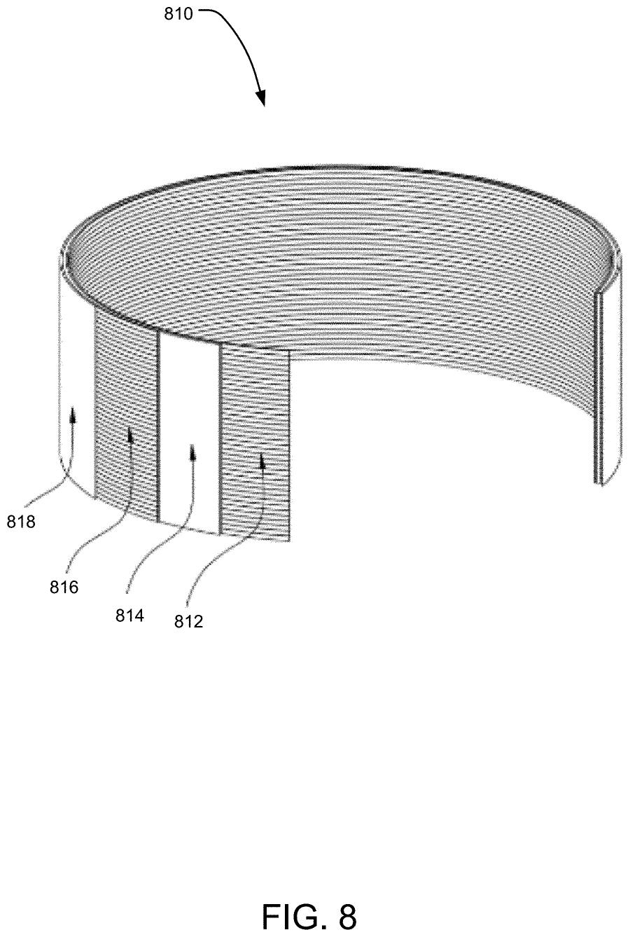

FIG. 8 illustrates a partial cut-away view of a shell body 810. The shell body 810 may comprise a plurality of layers. The plurality of layers may be laminated to form the cylindrical member of the shell body 810. For instance, as shown, the shell body 810 may include a first fiber-reinforced material 812, a first laminate layer 814, a second fiber-reinforced material 816, and a second laminate layer 818. As shown in FIG. 8, the first fiber-reinforced material 812 and the second fiber-reinforced material 816 may be in a common orientation, in which the reinforcing fibers extend circumferentially within the shell body 810. The first laminate layer 814 and the second laminate layer 818 may comprise a polymeric material. Each of the first fiber-reinforced material 812, the first laminate layer 814, the second fiber-reinforced material 816, and the second laminate layer 818 may be laminated to form the shell body 810.

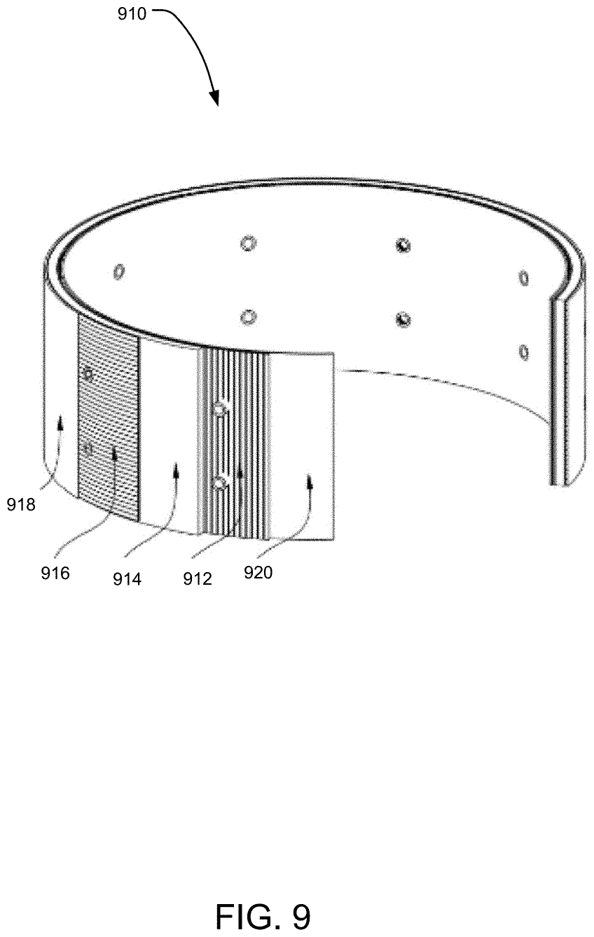

FIG. 9 illustrates a partial cut-away view of another example of a shell body 910. The shell body 910 may comprise a plurality of layers. The plurality of layers may be laminated to form the cylindrical member of the shell body 910. For instance, as shown, the shell body 910 may include a first fiber-reinforced material 912, a first laminate layer 914, a second fiber-reinforced material 916, and a second laminate layer 918, and a third laminate layer 920. As shown in FIG. 9, the first fiber-reinforced material 912 and the second fiber-reinforced material 916 may have different orientations. For example, the first fiber-reinforced material 912 may have an orientation such that the reinforcing fibers extend substantially axially relative to the shell body 910. In contrast, the second fiber-reinforced material 916 may have an orientation such that the reinforcing fibers extend substantially circumferentially relative to the shell body 910. The first laminate layer 914, the second laminate layer 918, and the third laminate layer 920 may comprise a polymeric material. Each of the first fiber-reinforced material 912, the first laminate layer 914, the second fiber-reinforced material 916, the second laminate layer 918, and the third laminate layer 920 may be laminated to form the shell body 910.

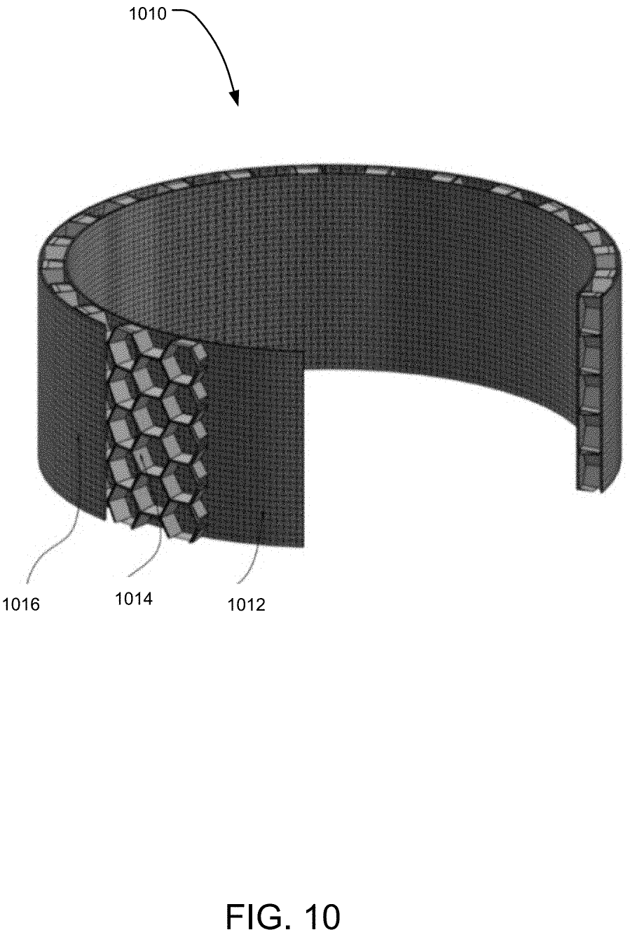

FIG. 10 illustrates yet another example of a shell body 1010. The shell body 1010 includes a first layer 1012, a second layer 1014, and a third layer 1016. The first layer 1012 and third layer 1016 may comprise any appropriate sheet material such as a polymeric sheet material including, for example, a fiber-reinforced polymeric sheet material. The second layer 1014 may include a material including cellular voids. For example, the second layer 1014 may comprise a honeycomb material defining cellular voids. The second layer 1014 may also comprise a polymeric material including, for example, a fiber-reinforced polymeric material. In turn, when laminated, the first layer 1012 and the third layer 1016 may enclose the cellular voids of the second layer 1014. Such use of honey-comb or other material defining cellular voids may be used to reduce the weight of the shell body 1010.

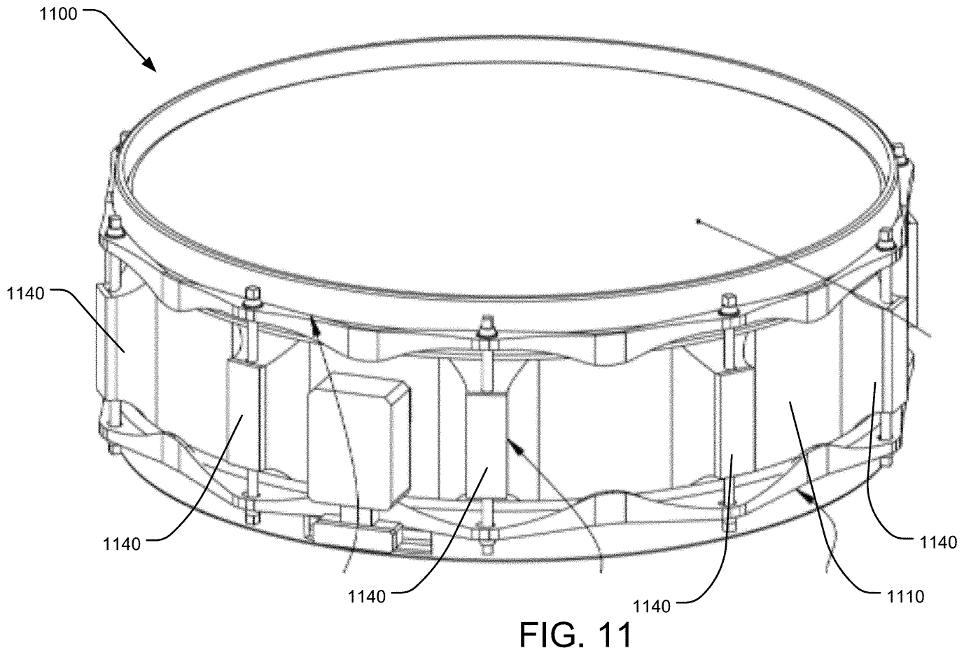

In another example, a shell body 1110 may comprise integrated tensioning lugs 1140 as shown in FIG. 11. In this regard, rather than a shell body comprising mounting locations for affixing tensioning lugs as described above, the shell body 1110 may include a sidewall that incorporates tensioning lugs 1140 into the shell body 1110.

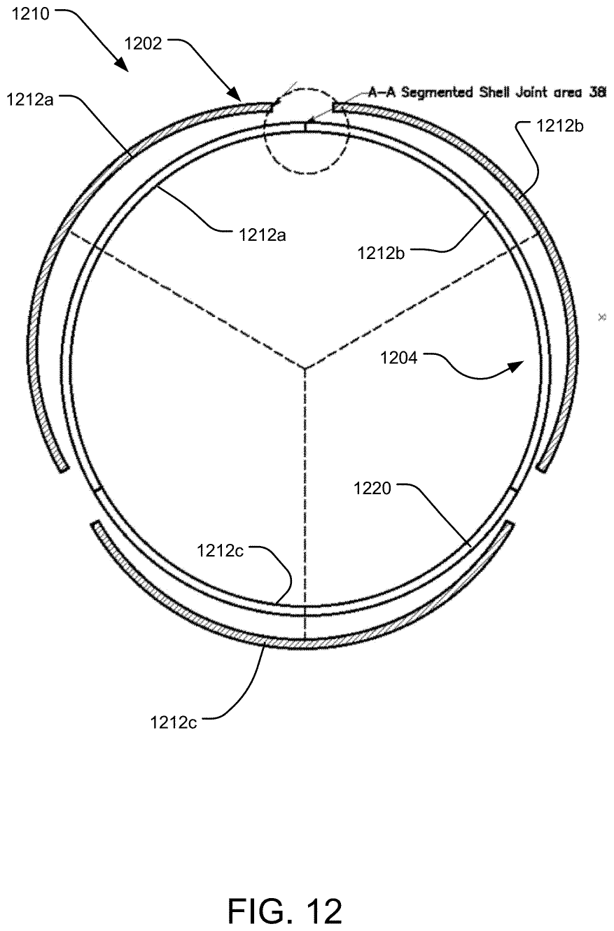

A shell body 1210 may also comprise a plurality of shell body segments 1212, as shown in FIG. 12. FIG. 12 depicts a top view of a first segment 1212a, a second segment 1212b, and a third segment 1212c. However, additional or fewer segments 1212 can be provided without limitation. FIG. 12 depicts the segments 1212 in a first, exploded configuration 1202 and a second, assembled configuration 1204 in which the segments 1212a, 1212b, and 1212c may be joined at respective end portions thereof to define a cylindrical body 1220.

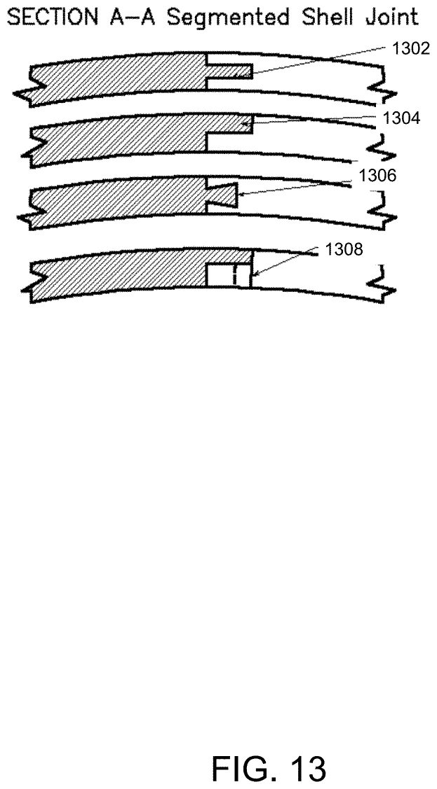

With further reference to FIG. 13, the segments of a shell body may be joined at respective end portions using any appropriate type of joint. FIG. 13 depicts some examples including but not limited to, a tongue and groove joint 1302, a lap joint 1304, a vertical dovetail joint 1306, and a horizontal crosswise dovetail joint 1308.

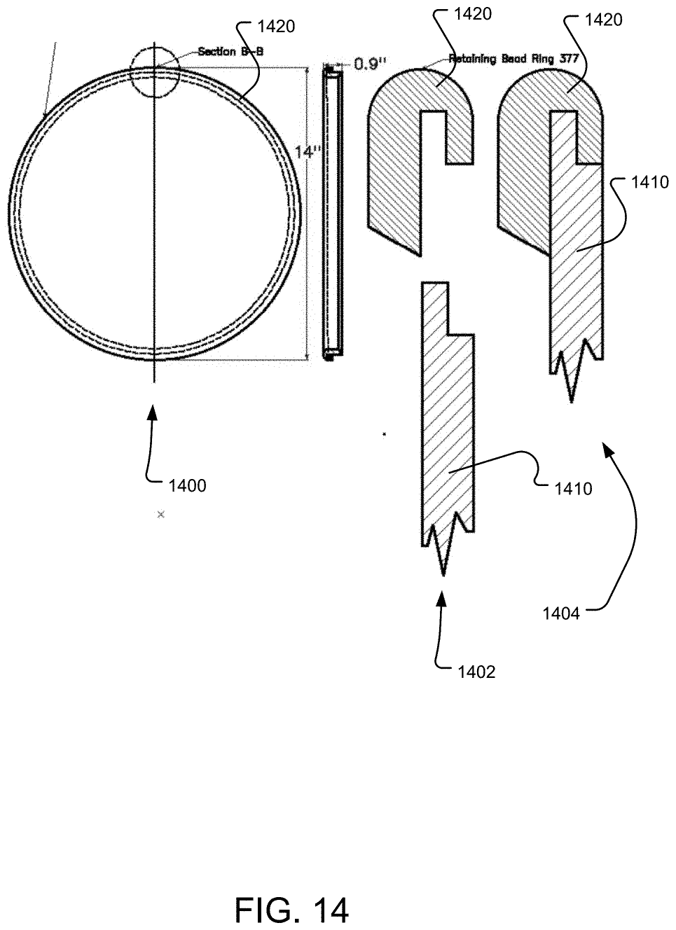

In addition, whether in the context of a unitary or segmented shell body, a unitary rim portion may be provided as a separate component joined to the shell body as shown in FIG. 14. FIG. 14 includes a first view 1400 that includes a top and side view of a unitary rim portion 1420. A second view 1402 depicts a cross-section view of the rim portion 1420 in an unattached configuration with a shell body 1410. A third view 1404 depicts the unitary rim portion 1420 affixed to the shell body 1410. While a tongue in groove joint is depicted in FIG. 14, it may be appreciated that any other type of joint between the unitary rim portion 1420 and the shell body 1410 may be provided without limitation. The unitary rim portion 1420 may comprise a polymeric material that may be the same or different than the shell body 1410.

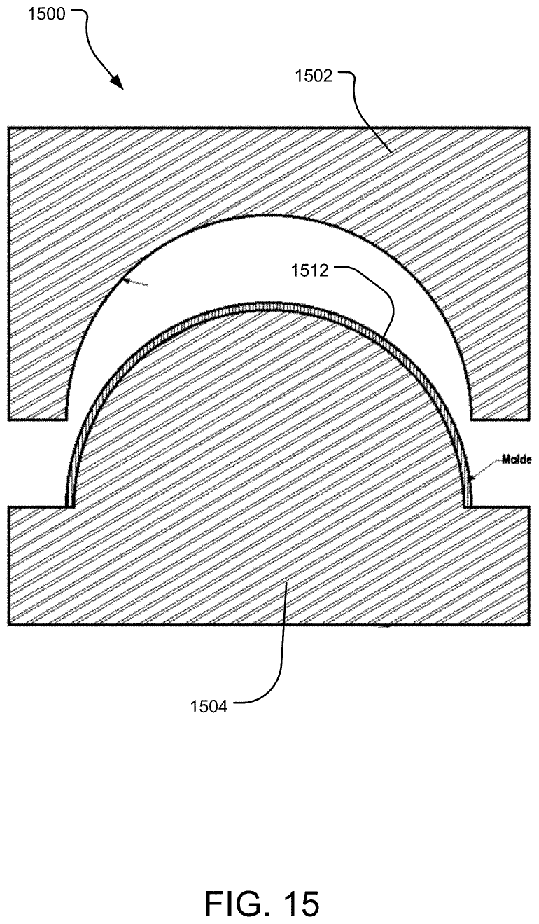

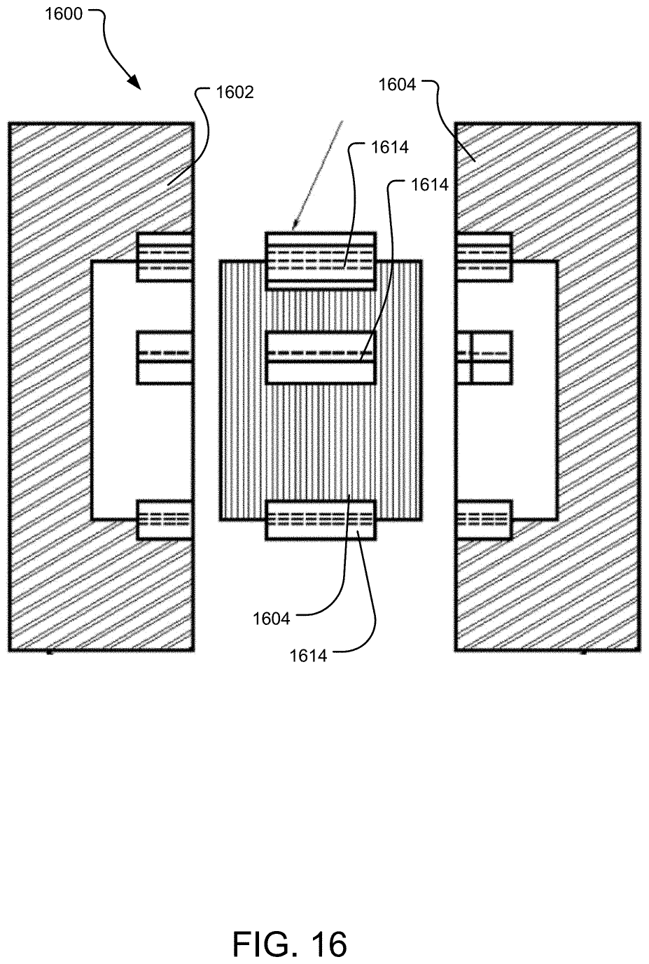

A shell body comprising a plurality of segments may provide advantages in relation to the manufacture of the shell body segments. In this regard, FIGS. 15 and 16 depict example molding configurations that may be used to mold a shell segment. In FIG. 15, a mold 1500 may include a first mold portion 1502 and a second mold portion 1504. A segment 1512 may be molded such that the first mold portion 1502 and the second mold portion 1504 separate along a radial direction relative to the segment 1512. In contrast, in FIG. 16, a mold 1600 may include a first mold portion 1602 and a second mold portion 1604. A segment 1612 may be molded such that the first mold portion 1602 and the second mold portion 1604 separate along an axial direction relative to the segment 1612. As shown in FIG. 16, tensioning lugs 1640 may also be formed integrally with the segment 1612.

An example of the present invention includes a percussion instrument that includes a shell body, a rim portion, and a tensioning ring. The shell body defines a cylindrical member having a circumferential edge portion and a first thickness. The cylindrical member extends about a central axis. In addition, the shell body is made from a first polymeric material. The rim portion is disposed at the circumferential edge portion, the rim portion has a second thickness greater than the first thickness and defines an outer diameter. The rim portion is made from the first polymeric material. The tensioning ring has an inner diameter greater than the outer diameter to facilitate a slip fit interface between the rim portion and the tensioning ring. The tensioning ring includes one or more reinforced portions of increased ring height in a dimension parallel to the central axis. Tensioning ring is made from a second polymeric material.

In an example, a plurality of tensioning lugs are provided on an exterior surface of the shell body extending away from the central axis. A plurality of tensioning apertures may be provided in the tensioning ring in corresponding relation to the plurality of tensioning lugs. The one or more reinforced portions of the increased ring height may extend between adjacent ones of the plurality of tensioning apertures. For example, the tensioning ring may include an annular wall and a flange. The flange includes a capture surface contactably engageable with a bead of a drumhead. The one or more reinforced portions may extend from the flange and external to the capture surface of the flange.

In an example, the first polymeric material and the second polymeric material may be the same material. In other examples, the first polymeric material and the second polymeric material may be different. In an example, the first polymeric material and/or the second polymeric material may be a composite polymeric material having not less than about 10% reinforcing fiber by weight. In another example, the first polymeric material and/or the second polymeric material may be a composite polymeric material having not less than about 20% reinforcing fiber by weight. In yet another example, the first polymeric material and/or the second polymeric material may be a composite polymeric material having not less than about 30% reinforcing fiber by weight. The first polymeric material and/or the second polymeric material may be a composite polymeric material having not less than about 1% reinforcing fiber by weight and not greater than about 75% reinforcing fiber by weight.

In an example, the shell body may include a plurality of segments joined together to define the cylindrical member.

In an example, the inner diameter is no more than about 0.200 inches (5.8 mm) greater than the outer diameter. In another example, the inner diameter is no more than about 0.100 inches (2.54 mm) greater than the outer diameter.

In an example, the first polymeric material and/or the second polymeric material comprise a thermoplastic material. The first polymeric material and/or the second polymeric material comprise a thermoset material. In an example, the shell body comprises a plurality of layers laminated to define the cylindrical member. At least one of the plurality of layers may include a plurality of cellular cavities.

Another example of the present disclosure includes a method for assembly of a percussion instrument. The method includes capturing a drumhead between a rim portion of a polymeric shell body having a central axis and a tensioning ring. In the capturing operation, a bead of the drumhead extends beyond an outer diameter of the rim portion of the shell body. The method also includes disposing the tensioning ring having an inner diameter greater than the outer diameter in a slip fit engagement with the rim portion. In turn, the method includes tensioning a plurality of tensioning members extending between the polymeric shell body and the tensioning ring to apply a tensioning force on the drumhead captured between the rim portion and the tensioning ring. The tensioning ring includes one or more reinforced portions of increased ring height in a dimension parallel to the central axis. The method also includes maintaining a substantially uniform tension of the drumhead in response to the tensioning.

In an example, the method also includes assembling the shell body by joining a plurality of segments together to define a cylindrical member of the shell body. In another example, the method includes joining the rim portion to a circumferential edge portion of the cylindrical member. The rim portion may be a continuous structure extending about the circumferential edge portion.

In an example, the method includes molding at least one of the plurality of segments such that a mold of at least one segment separates in a radial direction relative to the at least one segment. In another example, the method includes molding at least one of the plurality of segments such that a mold of at least one segment separates in an axial direction relative to the at least one segment.

In an example, the method includes laminating a plurality of layers of material to form the polymeric shell body.

Another example of the present invention includes a polymeric tensioning ring for a percussion instrument. The tensioning ring includes an annular wall extending about a central axis and a flange comprising a capture surface extending radially relative to the central axis and contactably engageable with a bead of a drumhead. The tensioning ring also includes one or more reinforced portions of increased ring height in a dimension parallel to the central axis, the one or more reinforced portions extending from the flange and external to the capture surface of the flange.

What is claimed is:

1. A percussion instrument, comprising:
a shell body comprising a cylindrical member having a circumferential edge portion and a first thickness, the cylindrical member extending about a central axis, and the shell body comprising a first polymeric material;
a rim portion disposed at the circumferential edge portion the rim portion comprising a second thickness greater than the first thickness and defining an outer diameter, the rim portion comprising the first polymeric material; and
a tensioning ring having an inner diameter greater than the outer diameter to facilitate a slip fit interface between the rim portion and the tensioning ring, the tensioning ring comprising one or more reinforced portions of increased ring height in a dimension parallel to the central axis, and the tensioning ring comprising a second polymeric material.

2. The percussion instrument of claim 1, further comprising:
a plurality of tensioning lugs disposed on an exterior surface of the shell body extending away from the central axis; and
a plurality of tensioning apertures defined in the tensioning ring in corresponding relation to the plurality of tensioning lugs, the one or more reinforced portions of the increased ring height extending between adjacent ones of the plurality of tensioning apertures.

3. The percussion instrument of claim 2, wherein the tensioning ring comprises:
an annular wall; and
a flange comprising a capture surface contactably engageable with a bead of a drumhead, the one or more reinforced portions extending from the flange and external to the capture surface of the flange.

4. The percussion instrument of claim 1, wherein the first polymeric material and the second polymeric material comprise a composite polymeric material having not less than about 10% reinforcing fiber by weight.

5. The percussion instrument of claim 1, wherein the first polymeric material and the second polymeric material comprise a composite polymeric material having not less than about 20% reinforcing fiber by weight.

6. The percussion instrument of claim 1, wherein the first polymeric material and the second polymeric material comprise a composite polymeric material having not less than about 30% reinforcing fiber by weight.

7. The percussion instrument of claim 1, wherein the first polymeric material and the second polymeric material comprise a composite polymeric material having not less than about 1% reinforcing fiber by weight and not greater than about 75% reinforcing fiber by weight.

8. The percussion instrument of claim 1, wherein the shell body comprises a plurality of segments joined together to define the cylindrical member.

9. The percussion instrument of claim 1, wherein the inner diameter is no more than about 0.200 inches (5.8 mm) greater than the outer diameter.

10. The percussion instrument of claim 1, wherein the inner diameter is no more than about 0.100 inches (2.54 mm) greater than the outer diameter.

11. The percussion instrument of claim 1, wherein the first polymeric material and the second polymeric material comprise a thermoplastic material.

12. The percussion instrument of claim 1, wherein the first polymeric material and the second polymeric material comprise a thermoset material.

13. The percussion instrument of claim 1, wherein the shell body comprises a plurality of layers laminated to define the cylindrical member.

14. The percussion instrument of claim 13, wherein at least one of the plurality of layers comprises a plurality of cellular cavities.

15. A method for assembly of a percussion instrument, comprising:
assembling a polymeric shell body by joining a plurality of segments together to define a cylindrical member of the polymeric shell body having a central axis;
joining a rim portion to a circumferential edge portion of the cylindrical member, wherein the rim portion comprises a continuous structure extending about the circumferential edge portion;
capturing a drumhead between the rim portion and a tensioning ring, a bead of the drumhead extending beyond an outer diameter of the rim portion of the shell body;
disposing the tensioning ring having an inner diameter greater than the outer diameter in a slip fit engagement with the rim portion;
tensioning a plurality of tensioning members extending between the polymeric shell body and the tensioning ring to apply a tensioning force on the drumhead captured between the rim portion and the tensioning ring, the tensioning ring comprising one or more reinforced portions of increased ring height in a dimension parallel to the central axis; and
maintaining a substantially uniform tension of the drumhead in response to the tensioning.

16. (canceled)

17. (canceled)

18. The method of claim 15, further comprising:
molding at least one of the plurality of segments such that a mold of at least one segment separates in a radial direction relative to the at least one segment.

19. The method of claim 15, further comprising:
molding at least one of the plurality of segments such that a mold of at least one segment separates in an axial direction relative to the at least one segment.

20. A method for assembly of a percussion instrument, comprising:
laminating a plurality of layers of material to form a polymeric shell body;
capturing a drumhead between a rim portion of the polymeric shell body having a central axis and a tensioning ring, a bead of the drumhead extending beyond an outer diameter of the rim portion of the shell body;
disposing the tensioning ring having an inner diameter greater than the outer diameter in a slip fit engagement with the rim portion;
tensioning a plurality of tensioning members extending between the polymeric shell body and the tensioning ring to apply a tensioning force on the drumhead captured between the rim portion and the tensioning ring, the tensioning ring comprising one or more reinforced portions of increased ring height in a dimension parallel to the central axis; and
maintaining a substantially uniform tension of the drumhead in response to the tensioning.

21. A polymeric tensioning ring for a percussion instrument, comprising:
an annular wall extending about a central axis;
a flange comprising a capture surface extending radially relative to the central axis and contactably engageable with a bead of a drumhead; and
one or more reinforced portions of increased ring height in a dimension parallel to the central axis, the one or more reinforced portions extending from the flange and external to the capture surface of the flange.
